(19) United States
(12) Patent Application Publication
(10) Pub. No.: US 2014/0225976 A1
(43) Pub. Date: Aug. 14, 2014

(54) SESSION INITIATION METHOD AND SYSTEM

(71) Applicant: TENCENT TECHNOLOGY (SHENZHEN) COMPANY LIMITED, Shenzhen (CN)

(72) Inventors: Yu ZHOU, Shenzhen (CN); Qian CHEN, Shenzhen (CN); Shiliang KANG, Shenzhen (CN); Zhengyuan QIU, Shenzhen (CN); Gong CHEN, Shenzhen (CN)

(21) Appl. No.: 14/254,925

(22) Filed: Apr. 17, 2014

Related U.S. Application Data
(63) Continuation of application No. PCT/CN2012/079437, filed on Jul. 31, 2012.

(30) Foreign Application Priority Data
Oct. 17, 2011 (CN) 201110316193.8

(51) Int. Cl. H04N 7/14; H04L 29/08

(52) U.S. Cl. CPC H04N 7/141; H04L 67/141
USPC 348/14.02

(57) ABSTRACT

The disclosure provides a session initiation method and a session initiation system. The method includes: a calling terminal transmits a call request message to a service server, and the service server transmits a call notification message to a push server according to the call request message; and, after a called terminal receives the call notification message transmitted by the push server, the called terminal establishes a network connection with the service server and acquires the call request message. With the disclosure, the initiation of session can be realized without the called terminal being online.

### CROSS REFERENCE TO RELATED APPLICATIONS

This application is a continuation application of International Patent Application No. PCT/CN2012/079437, entitled “SESSION INITIATION METHOD AND SYSTEM” filed on Jul. 31, 2012, which claims priority to the Chinese Patent Application No. 201110316193.8, entitled “SESSION INITIATION METHOD AND SYSTEM” filed on Oct. 17, 2011, both of which are incorporated by reference in their entirety.

### TECHNICAL FIELD

The disclosure relates to the field of communications, and in particular to a session initiation method and a session initiation system.

### BACKGROUND

In existing video session systems, a calling party and a called party are required to be online simultaneously while a video session is initiated. The online mentioned in the disclosure refers to that: a terminal of the calling party (calling terminal) and a terminal of the called party (called terminal) maintain network connection and heartbeat with a server of a video session service simultaneously, as shown in FIG. 1. When a video session is needed, the calling terminal transmits a call request to the server, which then forwards the call request to the called terminal.

However, since both the calling party and the called party in FIG. 1 are required to be online, the calling party and the called party need to maintain a network connection with the server at every moment, which imposes certain requirement on processing capability of the server. The called party needs to maintain network connection and heartbeat with the server at every moment. When the called terminal is a mobile terminal, the power consumption of the mobile terminal is relative large. Furthermore, the called party that is not online cannot be called, thus connection success rate of call is reduced.

### SUMMARY

In view of the above, a session initiation method and a session initiation system are provided, to realize initiation of session when a called party is not online.

In one aspect of the disclosure, a session initiation method is provided, which includes:

transmitting, by a calling terminal, a call request message to a service server;

transmitting, by the service server, a call notification message to a push server according to the call request message; and

establishing, by a called terminal, a network connection with the service server after the called terminal receives the call notification message transmitted by the push server, and acquiring the call request message.

In an embodiment of the disclosure, before the calling terminal transmits a call request message to the service server, the method further includes:

registering, by the called terminal, equipment identification code, called number and system type of the called terminal on the service server; and

correspondingly, recording, by the service server, a mapping relationship among the equipment identification code, the called number and the system type of the called terminal.

In an embodiment of the disclosure, the call request message may contain a calling number and a called number.

In an embodiment of the disclosure, after the calling terminal transmits the call request message to the service server, the method further includes:

saving, by the service server, the call request message, and searching for the equipment identification code and the system type of the corresponding called terminal, according to the called number contained in the call request message and the mapping relationship among the equipment identification code, the called number and the system type of the called terminal recorded in the service server itself.

In an embodiment of the disclosure, the transmitting, by the service server, a call notification message to the push server according to the call request message may include:

transmitting, by the service server, the call notification message to the push server corresponding to the found system type of the called terminal;

wherein, the call notification message contains the calling number and the equipment identification code of the called terminal.

In an embodiment of the disclosure, the receiving, by the called terminal, the call notification message transmitted by the push server may include:

forwarding, by the push server, the call notification message to the corresponding called terminal according to the equipment identification code of the called terminal contained in the call notification message.

In an embodiment of the disclosure, the establishing a network connection with the service server and acquiring the call request message may include:

after the called terminal receives the call notification message transmitted by the push server, initiating, by the called terminal, a session process and parsing the call notification message; and

establishing, by the called terminal, a network connection with the service server and acquiring the call request message from the service server according to the calling number contained in the call notification message.

In an embodiment of the disclosure, the service server may be a server providing video session services, and the push server may be an Apple Push Notification Service (APNS) server or a Google Server.

In another aspect of the disclosure, a session initiation method is provided, which includes:

receiving, by a service server, a call request message from a calling terminal and transmitting a call notification message to a push server according to the call request message; and

after the push server transmits the call notification message to a called terminal, establishing, by the service server, a network connection with the called terminal and providing the called terminal with the call request message.

In an embodiment of the disclosure, before the service server receives the call request message from the calling terminal by, the method further includes:

accepting, by the service server, a registration of equipment identification code, called number and system type of the called terminal and recording a mapping relationship among the equipment identification code, the called number and the system type of the called terminal.

In an embodiment of the disclosure, the call request message may contain a calling number and a called number.

In an embodiment of the disclosure, after the service server receives the call request message from the calling terminal, the method further includes:

saving, by the service server, the call request message, and searching for the equipment identification code and the system type of the corresponding called terminal, according to the called number contained in the call request message and the mapping relationship among the equipment identification code, the called number and the system type of the called terminal recorded in the service server itself.

In an embodiment of the disclosure, the transmitting, by the service server, a call notification message to the push server according to the call request message may include:

transmitting, by the service server, the call notification message to the push server corresponding to the found system type of the called terminal;

wherein, the call notification message may contain the calling number and the equipment identification code of the called terminal.

In an embodiment of the disclosure, the transmitting the call notification message to the called terminal by the push server may include:

forwarding, by the push server, the call notification message to the corresponding called terminal according to the equipment identification code of the called terminal contained in the call notification message.

In an embodiment of the disclosure, the establishing, by the service server, a network connection with the called terminal and providing the called terminal with the call request message may include:

establishing, by the service server, a network connection with the called terminal and providing the called terminal with the call request message corresponding to the calling number contained in the call notification message.

In an embodiment of the disclosure, the service server may be a server providing video session services, and the push server may be an APNS server or a Google Server.

In one aspect of the disclosure, a session initiation system is provided, which includes a service server and a push server.

The service server is configured to receive a call request message from a calling terminal and to transmit a call notification message to the push server according to the call request message.

The push server is configured to transmit the call notification message to a called terminal.

The service server is further configured to establish a network connection with the called terminal and to provide the called terminal with the call request message.

In an embodiment of the disclosure, the service server is further configured to accept a registration of equipment identification code, called number and system type of the called terminal, and to record the mapping relationship among the equipment identification code, the called number and the system type of the called terminal.

In an embodiment of the disclosure, the service server is further configured to save the call request message, and to search for the equipment identification code and the system type of the corresponding called terminal, according to the called number contained in the call request message and the mapping relationship among the equipment identification code, the called number and the system type of the called terminal recorded in the service server itself, and to transmit the call notification message to the push server corresponding to the found system type of the called terminal.

In an embodiment of the disclosure, the push server is further configured to forward the call notification message to the corresponding called terminal according to the equipment identification code of the called terminal contained in the call notification message.

In an embodiment of the disclosure, the service server is further configured to establish a network connection with the called terminal and to provide the called terminal with the call request message corresponding to the calling number contained in the call notification message.

With the session initiation method and system provided by the disclosure, the service server informs the push server of a call request for a called terminal, then the push server informs the called terminal, and finally the called terminal establishes a network connection with the service server to complete the initiation of session. Here, it can be seen that the called terminal has no network connection with the service server at the beginning, that is to say, in offline state, but establishes a network connection with the service server after obtaining through the push server a call request message indicating a session. In this way, the mode which does not require the called terminal to be online all the time reduces the requirement on the processing capability of server, also reduces the power consumption of mobile terminal. In addition, the mode that realizes the initiation of session without the called terminal being online also improves the connection success rate of call.

### BRIEF DESCRIPTION OF THE DRAWINGS

FIG. 1 shows a diagram of a conventional method for initiating a video session;

FIG. 2 shows a flowchart of a method for initiating a video session in the disclosure;

FIG. 3 shows a flowchart of a method for initiating a video session in the embodiment of the disclosure; and

FIG. 4 shows a flowchart of a method for initiating a video session at a server side in the disclosure.

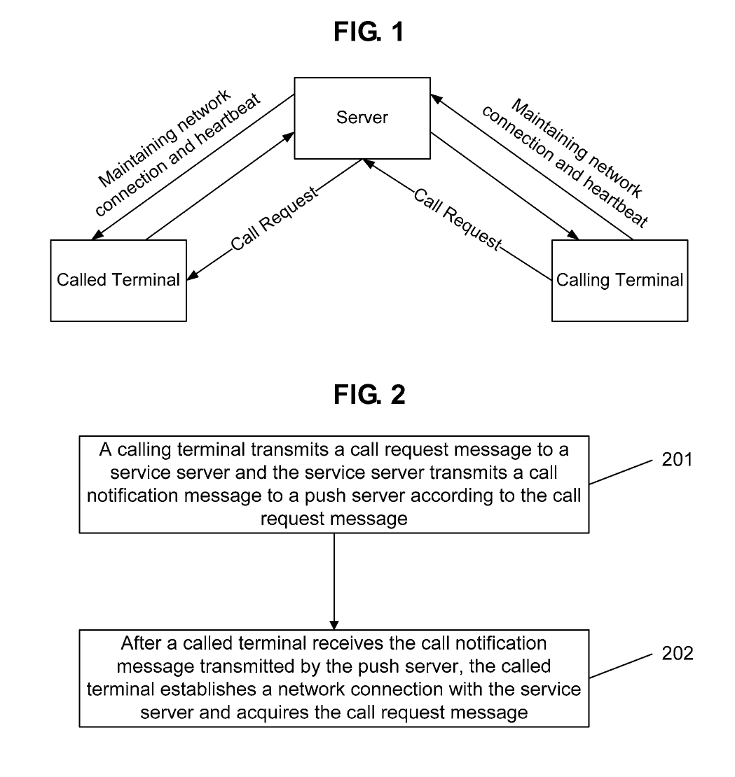

### DETAILED DESCRIPTION

In the embodiment of the disclosure, the main idea of initiating a session in the scene of a called terminal being offline is that: a service server informs a push server of a call request for the called terminal, then the push server informs the called terminal, and finally the called terminal establishes a network connection with the service server to complete the initiation of session.

In the embodiment of the disclosure, the service server is a server providing video session services; the push server depends on the application system of the terminal, for example, the push server corresponding to the terminal using an ios system is an APNS server, and the push server corresponding to the terminal using an Android system is a Google server.

As shown in FIG. 2, the method for initiating a video session in the embodiment of the disclosure includes the following steps:

Step 201: A calling terminal transmits a call request message to a service server and the service server transmits a call notification message to a push server according to the call request message.

Before the calling terminal transmits the call request message to the service server, it is necessary to execute the following operations: a called terminal registers equipment identification code, called number and system type of the called terminal on the service server; correspondingly, the service server records the mapping relationship among the equipment identification code, the called number and the system type of the called terminal.

Further, the call request message contains a calling number and a called number. After the calling terminal transmits the call request message to the service server, the service server saves the call request message, and searches for the equipment identification code and the system type of the corresponding called terminal, according to the called number contained in the call request message and the mapping relationship recorded in the service server itself. Further, the service server transmits a call notification message to the push server corresponding to the found system type of the called terminal, wherein the call notification message contains the calling number and the found equipment identification code of the called terminal. Then, the push server forwards the call notification message to the corresponding called terminal according to the equipment identification code of the called terminal contained in the call notification message.

Step 202: After a called terminal receives the call notification message transmitted by the push server, the called terminal establishes a network connection with the service server and acquires the call request message.

After the called terminal receives the call notification message transmitted by the push server, the called terminal initiates a session process and parses the call notification message; then, the called terminal establishes a network connection with the service server and acquires the corresponding call request message from the service server according to the calling number contained in the parsed call notification message. Thus, the initiation of session is completed.

From the entire process it can be seen that the called terminal has no network connection established with the service server at the beginning, that is to say, in offline state, but establishes a network connection with the service server after obtaining through the push server a call request message indicating a session and then acquires the call request message.

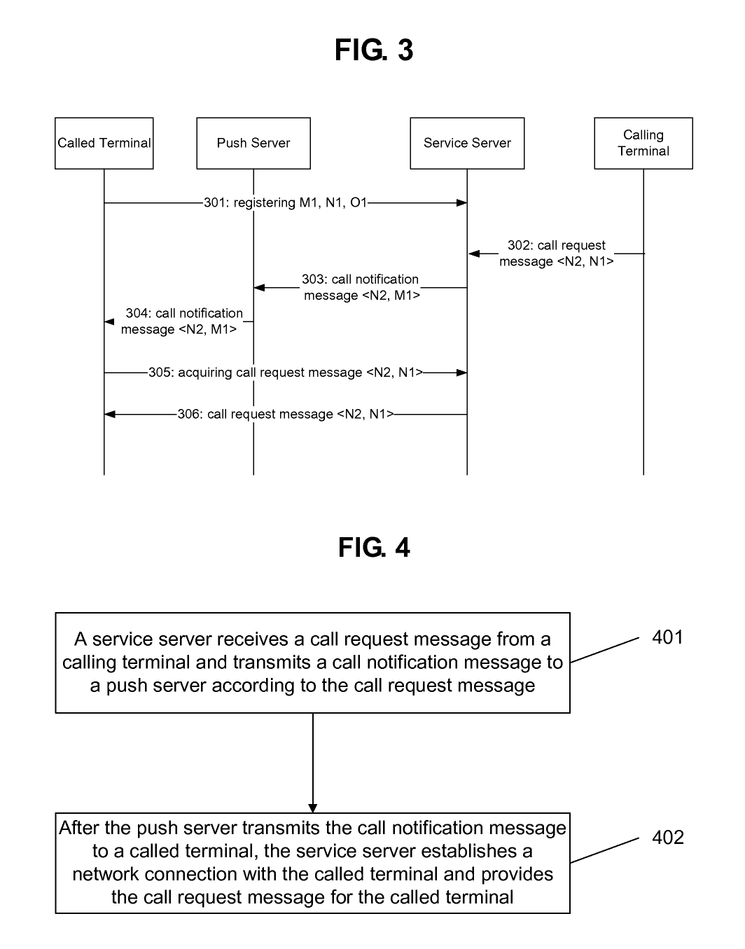

Hereinafter, the above technical solution is described in detail by taking the initiation of a video session of a mobile terminal (the type of the calling terminal and the called terminal is mobile terminal) for example; as shown in FIG. 3, the process includes the following steps:

Step 301: The called terminal performs registration of following items on the service server: equipment identification code M1 of the called terminal, called number N1 and system type O1 of the called terminal.

For the equipment identification M1 of the called terminal, if the called terminal uses an ios system, then each mobile terminal has a unique binary code, which is of fixed 32 bytes; if the called terminal uses an Android system, then the called terminal can register on a Google server to acquire its own equipment identification code, which is an undefined character string.

The called number N1 refers to the identification number of a called user when the called user uses a service. For example, for a QQ user, N1 refers to QQ number; and for an MSN user, N1 refers to the MSN user name. Thus, a called user can have different called numbers when the called user performs different services using the called terminal.

The system type O1 of the called terminal can be, for example, ios or Android.

The called terminal uploads M1, N1 and O1 to the service server, which then records the mapping relationship among the three ones to complete the registration of the called party on the service server, wherein the mapping relationship can be expressed as Bind<N1, M1, O1>.

Step 302: When it is needed to initiate a video session service, the calling terminal initiates a call to the called terminal, specifically, the calling terminal transmits a call request message to the service server, wherein the call request message contains the calling number N2 and the called number N1, and the call request can be expressed as Invite <N2, N1>. Then, the service server saves the call request message Invite <N2, N1>.

Step 303: The service server searches for the equipment identification M1 and the system type O1 of the corresponding called terminal, according to the called number N1 and the recorded mapping relationship Bind <N1, M1, O1>.

According to the system type O1 of the called terminal, the service server transmits a call notification message to a corresponding push server, wherein the call notification message differs depending on O1, for example, if O1 indicates ios, the call notification message transmitted to an APNS server from the service server is an Apple Push Notification Service (APNS) notification message; if O1 indicates Android, the call notification message transmitted to a Google server from the service server is an Android Cloud to Device Messaging (C2DM) notification message.

The call notification message contains the calling number N2 and the equipment identification code M1 of the called terminal, wherein the call notification can be expressed as Notification <N2, M1>. According to the equipment identification code M1 of the called terminal, the push server can transmit the call notification message to the corresponding called terminal.

Step 304: The push server forwards the call notification message Notification <N2, M1> to the called terminal.

After receiving the call notification message forwarded by the push server, the called terminal initiates a video session program, and parses the call notification message Notification <N2, M1>.

Step 305 to Step 306: The called terminal establishes a connection with the service server, and acquires the corresponding call request message Invite <N2, N1> from the service server according to the calling number N2 in the parsed call notification message.

After the called terminal acquires the call request message, the called user determines whether or not to accept the video session initiated by the calling user.

It should be noted that the method mentioned in the embodiment of the disclosure is not limited to the initiation of video session, but also is applicable to the initiation of audio session. In addition, the method mentioned in the embodiment of the disclosure is not limited to mobile terminals, but also is applicable to other terminals which can establish a network connection with the service server and can perform session services.

In order to clearly describe the session initiation method in the embodiment of the disclosure, the embodiment of the disclosure also provides a method for initiating a session at a server side. As shown in FIG. 4, the session initiation method in this embodiment includes the following steps:

Step 401: A service server receives a call request message from a calling terminal and transmits a call notification message to a push server according to the call request message.

The call request message contains a calling number and a called number.

Before the service server receives the call request message from the calling terminal, the service server accepts the registration of equipment identification code of the called terminal, called number and system type of the called terminal, and records the mapping relationship among the equipment identification code of the called terminal, the called number and the system type of the called terminal.

After the service server receives the call request message from the calling terminal, the service server saves the call request message, and searches for the equipment identification code and the system type of the corresponding called terminal, according to the called number contained in the call request message and the mapping relationship among the equipment identification code, the called number and the system type of the called terminal recorded in the service server itself.

Specifically, the transmitting a call notification message to the push server according to the call request message by the service server includes that: the service server transmits the call notification message to the push server corresponding to the found system type of the called terminal, wherein the call notification message contains the calling number and the equipment identification code of the called terminal.

Step 402: After the push server transmits the call notification message to the called terminal, the service server establishes a network connection with the called terminal and provides the call request message for the called terminal.

Specifically, the transmitting the call notification message to the called terminal by the push server includes that:

the push server forwards the call notification message to the corresponding called terminal according to the equipment identification code of the called terminal contained in the call notification message.

After the service server establishes a network connection with the called terminal, the service server provides the called terminal with the call request message corresponding to the calling number contained in the call notification message.

The embodiment of the disclosure further provides a session initiation system to implement the above method. The session initiation system includes a service server and a push server.

The service server is configured to receive a call request message from a calling terminal and to transmit a call notification message to the push server according to the call request message.

The push server is configured to transmit the call notification message to a called terminal.

The service server is further configured to establish a network connection with the called terminal and to provide the call request message for the called terminal.

In an embodiment of the disclosure, the service server is further configured to accept the registration of equipment identification code, called number and system type of the called terminal, and to record the mapping relationship among the equipment identification code, the called number and the system type of the called terminal.

In an embodiment of the disclosure, the service server is further configured to save the call request message, and to search for the equipment identification code and the system type of the corresponding called terminal, according to the called number contained in the call request message and the mapping relationship among the equipment identification code, the called number and the system type of the called terminal recorded in the service server itself, and to transmit the call notification message to the push server corresponding to the found system type of the called terminal.

In an embodiment of the disclosure, the push server is further configured to forward the call notification message to the corresponding called terminal according to the equipment identification code of the called terminal contained in the call notification message.

In an embodiment of the disclosure, the service server is further configured to establish a network connection with the called terminal and to provide the called terminal with the call request message corresponding to the calling number contained in the call notification message.

With the session initiation method and system provided by the embodiment of the disclosure, the service server informs the push server of a call request for a called terminal, then the push server informs the called terminal, and finally the called terminal establishes a network connection with the service server to complete the initiation of session. Here, it can be seen that the called terminal has no network connection with the service server at the beginning, that is to say, in offline state, but establishes a network connection with the service server after obtaining through the push server a call request message indicating a session. In this way, the mode that does not require the called terminal to be online all the time reduces the requirement on the processing capability of server, also reduces the power consumption of mobile terminal; in addition, the mode that realizes the initiation of session without the called terminal being online also improves the connection success rate of call.

If the integrated module described in the embodiment of the disclosure is implemented in the form of software function module and is sold or used as an independent product, the integrated module also can be stored in a computer readable storage medium. Based on this understanding, the technical solution of the disclosure essentially or the part making a contribution to prior art can be embodied in the form of software product. This computer software product is stored in a storage medium, including a plurality of instructions used for enabling a computer device (which can be computer, server or network device) to execute all or part of the method described in each embodiment of the disclosure. The storage medium includes: USB flash disk, mobile hard disk, Read-Only Memory (ROM), Random Access Memory (RAM), magnetic disk or compact disk and various mediums capable of storing program codes. In this way, the embodiment of the disclosure is not limited to any combination of specific hardware and software

The above are only the preferred embodiments of the disclosure and are not intended to limit the scope of protection of the disclosure.

1. A session initiation method, comprising:
transmitting, by a calling terminal, a call request message to a service server;
transmitting, by the service server, a call notification message to a push server according to the call request message; and
establishing, by a called terminal, a network connection with the service server after the called terminal receives the call notification message transmitted by the push server, and acquiring the call request message.

2. The session initiation method according to claim 1, further comprising the step, performed before the transmitting a call request message to the service server by the calling terminal, of:
registering, by the called terminal, equipment identification code, called number and system type of the called terminal on the service server; and
correspondingly, recording, by the service server, a mapping relationship among the equipment identification code, the called number and the system type of the called terminal.

3. The session initiation method according to claim 2, wherein the call request message contains a calling number and a called number.

4. The session initiation method according to claim 3, further comprising the step, performed after the transmitting the call request message to the service server by the calling terminal, of:
the service server saving the call request message, and finding the equipment identification code and the system type of the corresponding called terminal, according to the called number contained in the call request message and the mapping relationship among the equipment identification code, the called number and the system type of the called terminal recorded in the service server itself.

5. The session initiation method according to claim 4, wherein the transmitting, by the service server, a call notification message to the push server according to the call request message comprises:
transmitting, by the service server, the call notification message to the push server corresponding to the found system type of the called terminal;
wherein, the call notification message contains the calling number and the equipment identification code of the called terminal.

6. The session initiation method according to claim 5, wherein the receiving, by the called terminal, the call notification message transmitted by the push server comprises:
forwarding, by the push server, the call notification message to the corresponding called terminal according to the equipment identification code of the called terminal contained in the call notification message.

7. The session initiation method according to claim 6, wherein the establishing a network connection with the service server and acquiring the call request message comprises:
after the called terminal receives the call notification message transmitted by the push server, initiating, by the called terminal, a session process and parsing the call notification message; and
establishing, by the called terminal, a network connection with the service server and acquiring the call request message from the service server according to the calling number contained in the call notification message.

8. The session initiation method according to claim 1, wherein
the service server is a server providing video session services, and the push server is an APNS server or a Google Server.

9. A session initiation method, comprising:
receiving, by a service server, a call request message from a calling terminal and transmitting a call notification message to a push server according to the call request message; and
establishing, by the service server, a network connection with the called terminal after the push server transmits the call notification message to a called terminal, and providing the call request message to the called terminal.

10. The session initiation method according to claim 9, further comprising the step, performed before the receiving the call request message from the calling terminal by the service server, of:
accepting, by the service server, a registration of equipment identification code, called number and system type of the called terminal, and recording a mapping relationship among the equipment identification code, the called number and the system type of the called terminal.

11. The session initiation method according to claim 10, wherein the call request message contains a calling number and a called number.

12. The session initiation method according to claim 11, further comprising the step, performed after the receiving the call request message from the calling terminal by the service server, of:
saving, by the service server, the call request message, and searching for the equipment identification code and the system type of the corresponding called terminal, according to the called number contained in the call request message and the mapping relationship among the equipment identification code, the called number and the system type of the called terminal recorded in the service server itself.

13. The session initiation method according to claim 12, wherein the transmitting, by the service server, a call notification message to the push server according to the call request message comprises:
transmitting, by the service server, the call notification message to the push server corresponding to the found system type of the called terminal;
wherein, the call notification message contains the calling number and the equipment identification code of the called terminal.

14. The session initiation method according to claim 13, wherein the transmitting, by the push server, the call notification message to the called terminal comprises:
forwarding, by the push server, the call notification message to a corresponding called terminal according to the equipment identification code of the called terminal contained in the call notification message.

15. The session initiation method according to claim 14, wherein the establishing, by the service server, a network connection with the called terminal and providing the called terminal with the call request message comprises:
establishing, by the service server, a network connection with the called terminal and providing the called terminal with the call request message corresponding to the calling number contained in the call notification message.

16. The session initiation method according to claim 9, wherein the service server is a server providing video session services, and the push server is an APNS server or a Google Server.

17. A session initiation system, comprising a service server and a push server, wherein
the service server is configured to receive a call request message from a calling terminal and to transmit a call notification message to the push server according to the call request message;
the push server is configured to transmit the call notification message to a called terminal; and
the service server is further configured to establish a network connection with the called terminal and to provide the call request message to the called terminal.

18. The session initiation system according to claim 17, wherein
the service server is further configured to accept a registration of equipment identification code, called number and system type of the called terminal, and to record a mapping relationship among the equipment identification code, the called number and the system type of the called terminal.

19. The session initiation system according to claim 18, wherein
the service server is further configured to:
save the call request message;
search for the equipment identification code and the system type of the corresponding called terminal, according to the called number contained in the call request message and the mapping relationship among the equipment identification code, the called number and the system type of the called terminal recorded in the service server itself; and
transmit the call notification message to the push server corresponding to the found system type of the called terminal.

20. The session initiation system according to claim 19, wherein the push server is further configured to forward the call notification message to the corresponding called terminal according to the equipment identification code of the called terminal contained in the call notification message.

21. The session initiation system according to claim 20, wherein
the service server is further configured to establish a network connection with the called terminal and to provide the called terminal with the call request message corresponding to the calling number contained in the call notification message.
